(19) United States
(12) Patent Application Publication
(10) Pub. No.: US 2019/0270670 A1
(43) Pub. Date: Sep. 5, 2019

(54) APPARATUS AND METHOD FOR MASKING THE PERIMETER EDGE OF A GLASS-BASED ARTICLE DURING A COATING PROCESS AND ARTICLES PRODUCED THEREBY

(71) Applicant: CORNING INCORPORATED, CORNING, NY (US)

(72) Inventors: Jae-chang Lee, Seoul (KR); Dong-gun Moon, Yongin-si (KR)

(21) Appl. No.: 16/347,113

(22) PCT Filed: Oct. 31, 2017
(86) PCT No.: PCT/US2017/059333

§ 371 Date: May 2, 2019

(30) Foreign Application Priority Data
Nov. 4, 2016 (KR) 10-2016-0146621

(51) Int. Cl. C03C 17/36; C03C 17/00; B05B 12/20

(52) U.S. Cl. CPC C03C 17/3607; C03C 2218/34; B05B 12/20; C03C 17/002

(57) ABSTRACT

Methods for coating a glass-based article, for example a cover glass, with a coating layer that is not deposited on the perimeter edge of the glass-based article. The methods may include disposing a mask having an eave over a glass-based article to protect perimeter portions of the glass-based article from coating of the coating layer during a deposition process. The eave may be dimensioned to form a coating layer having non-uniform coating thickness region around the edge of the coating layer that is not visible to the naked eye on the surface of a glass-based article. The methods may be used to make a glass-based article with non-edge-to-edge coating layers.

### BACKGROUND

### Cross-Reference to Related Applications

This application claims the benefit of priority under 35 U.S.C. § 119 of Korean Application No. 10-2016-0146621 filed on Nov. 4, 2016, the content of which is relied upon and incorporated herein by reference in its entirety.

### Field

The present disclosure relates to coating of a glass-based article, for example, a cover glass. In particular, the present disclosure relates to protecting the perimeter edge of a glass-based article from coating during a coating deposition process.

### Background

Glass-based articles, for example cover glass, such as for example, cover glass for a mobile phone, may be manufactured with one or more surface treatments to enhance its functions and provide a positive experience for an end user. For example, cover glass may be coated with one or more coating layers to provide desired characteristics. Such coating layers include anti-reflection coating layers, easy-to-clean coating layers, and scratch resistant coating layers. These coating layers can be applied on a surface of the cover glass using various vacuum deposition methods for example sputtering, physical vapor deposition (PVD), and chemical vapor deposition (CVD). These coating layers may be applied to an entire surface of the cover glass, i.e., an edge-to-edge coating of a cover glass surface. In some cases, a pressure sensitive adhesive (e.g., double-sided Kapton tape) may be used to hold cover glass on a support plate during an edge-to-edge coating process.

A scratch resistant coating layer can provide a glass surface (e.g., a cover glass' surface) with the characteristic of very high hardness, which may prevent formation of scratches on the glass surface and minimize the possibility of glass failure (e.g., fracture) during use. Such a coating layer should provide a high degree of hardness without adversely affecting other properties of the cover glass (e.g., other mechanical properties). Therefore, a continuing need exists for innovations in coating layers for glass-based articles and methods of depositing these coating layers on a surface of the glass-based articles.

### BRIEF SUMMARY

The present disclosure is directed to glass-based articles, for example cover glasses, and methods for coating desired regions on a surface of a glass-based article with a coating layer.

Some embodiments are directed towards a method of coating a glass-based article, the method including disposing a mask over a glass-based article and depositing a coating layer over the glass-based article while the mask is disposed over the glass-based article, where (a) the glass-based article has a perimeter edge, a first annular perimeter portion disposed inside and extending from the perimeter edge, a second annular perimeter portion disposed inside and extending from the first annular perimeter portion, and an inner portion disposed inside the second annular perimeter portion; (b) the mask includes an aperture having a periphery with an eave comprising an edge thickness of 0.3 mm or less; and (c) when the mask is disposed over the glass-based article: the mask contacts at least a portion of the first annular perimeter portion of the glass-based article; the eave extends over the second annular perimeter portion of the glass-based article; the aperture is disposed over the inner portion of the glass-based article; and a bottom surface of the eave is disposed at least 150 micrometers (microns) above the second annular perimeter portion of the glass-based article.

In some embodiments, the method according to the embodiments of the preceding paragraph may include a mask wherein an upper surface of the eave has a positive slope of 30 degrees or less extending away from the edge of the eave, measured relative to a plane of the glass-based article.

In some embodiments, the embodiments of any of the preceding paragraphs may further include fixing the glass-based article to a base plate with the mask when disposing the mask over the glass-based article.

In some embodiments, the embodiments of any of the preceding paragraphs may include a glass-based article including two long sides having a length measured in a first direction and two short sides having a length measured in a second direction perpendicular to the first direction and, at room temperature before deposition of the coating layer, the eave may extend over the second annular perimeter portion of the long sides of the glass-based article by a first distance and may extend over the second annular perimeter portion of the short sides of the glass-based article by a second distance that is different from the first distance. In some embodiments, the first distance may be less than the second distance.

In some embodiments, the embodiments of any of the preceding paragraphs may include a first annular portion beginning at the perimeter edge of the glass-based article and extending to a distance A inside the perimeter edge, where A is in the range of 0.1 mm to 1.0 mm, and/or a second annular portion beginning at an interior edge of the first annular perimeter portion and extending to a distance B inside the interior edge of the first annular perimeter portion, where B is in the range of 0.5 mm to 2.0 mm.

In some embodiments, the embodiments of any of the preceding paragraphs may include a first annular portion beginning at the perimeter edge of the glass-based article and extending a distance A inside the perimeter edge and a second annular portion may begin at an interior edge of the first annular perimeter portion and extend to a distance B inside the interior edge of the first annular perimeter portion, where the sum of A and B is less than or equal to 3.0 mm.

In some embodiments, the embodiments of any of the preceding paragraphs may include a coating layer including a scratch resistant coating layer.

In some embodiments, the embodiments of any of the preceding paragraphs may include a coating layer deposited over a least a portion of the second annular perimeter portion of the glass-based article.

In some embodiments, the embodiments of any of the preceding paragraphs may include a coating layer including a non-uniform coating thickness in the second annular perimeter portion of the glass-based article. In some embodiments, the non-uniform coating thickness may gradually decrease in thickness when moving from the inner portion towards the first annular perimeter portion of the glass-based article. In some embodiments, the non-uniform coating thickness may not be visible to the naked eye on the glass-based article.

In some embodiments, the embodiments of any of the preceding paragraphs may include a mask including an elastic portion that contacts at least a portion of the first annular perimeter portion of the glass-based article when the mask is disposed over the glass-based article.

In some embodiments, the embodiments of any of the preceding paragraphs may include a glass-based article that is a cover glass.

Some embodiments are direct towards an apparatus for masking the perimeter edge of a glass-based article during a coating process, the apparatus including a mask having a contact portion configured to contact a first annular perimeter portion of the glass-based article; and an eave portion configured to extend over a second annular perimeter portion of the glass-based article, the eave portion defining an aperture and including an upper surface, a bottom surface and a peripheral edge, where the peripheral edge has an edge thickness of 0.3 mm or less measured at 250 degrees C., and where the bottom surface of the eave portion at the peripheral edge is configured to be located at least 150 microns above an interior edge of a second annular perimeter portion of the glass-based article at a temperature of 250 degrees C.

In some embodiments, the apparatus according to embodiments of the preceding paragraph may include an eave portion with an upper surface having a slope of 30 degrees or less measured relative to the bottom surface at a temperature of 250 degrees C.

In some embodiments, the apparatus according to embodiments of any of the preceding paragraphs may include a mask having a contact portion that includes an elastic material.

In some embodiments, at room temperature, the apparatus according to embodiments of any of the preceding paragraphs may include a mask having an eave portion including two long sides having a length measured in a first direction and two short sides having a length measured in a second direction perpendicular to the first direction, the long sides may extend from the contact portion by a first distance, and the short sides may extend from the contact portion by a second distance different from the first distance. In some embodiments, the first distance may be less than the second distance.

In some embodiments, the apparatus according to embodiments of any of the preceding paragraphs may include a base plate configured to hold the glass-based article in a predetermined position. In some embodiments, the apparatus may include a glass-based article disposed on the base plate and releasably fixed to the base plate with the mask.

Some embodiments are directed towards an article including a cover glass including a body having a top surface with a perimeter portion and a central portion, the perimeter portion including at least a portion of a perimeter edge of the top surface; and a scratch resistant coating disposed on the central portion but not on the perimeter portion, the scratch resistant coating including a non-uniform coating thickness region at the periphery of the scratch resistant coating adjacent to the perimeter portion.

In some embodiments, the article according to embodiments of the preceding paragraph may include an article that is a consumer electronic product including a housing having a front surface, a back surface and side surfaces; electrical components provided at least partially within the housing, the electrical components including at least a controller, a memory, and a display, the display being provided at or adjacent the front surface of the housing; and a cover glass according to embodiments of the preceding paragraph disposed over the display.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates an exploded view of an apparatus for masking the periphery of a cover glass according to some embodiments.

FIG. 2 illustrates a cover glass according to some embodiments.

FIG. 3 illustrates a cross-sectional view of a base plate and a mask according to some embodiments.

FIG. 4 illustrates a cross-sectional view of a base plate and a mask according to some embodiments.

FIG. 5 illustrates a cover glass and an article according to some embodiments.

FIG. 6 illustrates a side view of the cover glass in FIG. 5.

FIG. 7A is a photograph of a first cover glass. FIG. 7B is photograph of a second cover glass. FIG. 7C is a photograph of a third cover glass.

FIG. 8A is a microscope image of a coating layer having a visible edge. FIG. 8B is a microscopic image of a coating layer having a non-visible edge.

FIG. 9 is a graph of the coating profile for a coating layer according to some embodiments.

FIG. 10A illustrates an eave extending over a periphery of a cover glass at an elevated temperature during a coating deposition process according to some embodiments. FIG. 10B illustrates an eave extending over a periphery of a cover glass at room temperature according to some embodiments.

FIG. 11 illustrates a bottom view of a mask according to some embodiments.

FIG. 12 illustrates an eave extending over a periphery of a cover glass according to some embodiments.

FIGS. 13A-13C illustrate eaves according to various embodiments.

FIG. 14 illustrates a cross-sectional view of a base plate and mask according to some embodiments.

FIG. 15 illustrates a cross-sectional view of a base plate and mask according to some embodiments.

FIGS. 16A-16C illustrate cover glass edges according to various embodiments.

FIG. 17 illustrates a cross-sectional view of a base plate and mask.

FIG. 18 illustrates a consumer product according to some embodiments.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Coating layers for glass-based articles, for example a cover glass, may serve to, among other things, reduce undesired reflections, prevent formation of mechanical defects in the glass (e.g., scratches or cracks), and/or provide an easy to clean transparent surface. The glass-based articles disclosed herein may be incorporated into another article such as an article with a display (or display articles) (e.g., consumer electronic products, including mobile phones, tablets, computers, navigation systems, wearable devices (e.g., watches) and the like), architectural articles, transportation articles (e.g., automotive, trains, aircraft, sea craft, etc.), appliance articles, or any article that requires some transparency, scratch-resistance, abrasion resistance or a combination thereof. An exemplary article incorporating any of the glass-based articles disclosed herein is a consumer electronic device including a housing having front, back, and side surfaces; electrical components that are at least partially inside or entirely within the housing and including at least a controller, a memory, and a display at or adjacent to the front surface of the housing; and a cover substrate at or over the front surface of the housing such that it is over the display. In some embodiments, the cover substrate may include any of the glass-based articles disclosed herein. In some embodiments, at least one of a portion of the housing or the cover glass comprises the glass-based articles disclosed herein.

Coating layers for glass-based articles should provide one or more desirable characteristics without detrimentally affecting other characteristics of the glass-based article. For example, it has been observed that edge-to-edge coating of a scratch resistant coating layer may negatively affect the edge strength of cover glass and may decrease the 4-point bending strength and impact strength of the cover glass. These negative effects are attributed to the high stiffness and hardness of a scratch resistant coating layer located on the edges of the cover glass (e.g., perimeter edges). Since impact strength is directly related to the drop performance, inclusion of a scratch resistant coating may weaken the structural integrity of a cover glass installed on an electronic device. This is undesirable because the formation of cracks or the complete fracture of the cover glass may make use of an electronic device difficult for a user and may expose components of the electronic device (e.g., display components) to environmental elements that may be harmful to those components.

The coating process and tools used to deposit coating layers, for example scratch resistant coating layers, may be tailored to provide desired characteristics without detrimentally affecting other characteristics of a glass-based article. For example, a coating process that prevents the formation of a coating layer at and around the perimeter edges of a glass-based article (e.g., a cover glass) may minimize any detrimental effects resulting from edge-to-edge coating of such a coating layer.

While preventing edge-to-edge coating may be beneficial for the structural integrity of a glass-based article, a process for preventing such edge-to-edge coatings that also creates coating layers with edges that are not visible to the naked eye during use of the glass-based article may be beneficial in some instances. A coating edge that is visible to the naked eye during use of the glass-based article may be aesthetically undesirable and distracting to a user. The masks discussed herein prevent edge-to-edge coating of one or more coating layers on a glass-based article while also forming coating edges that are not visible to the naked eye during use.

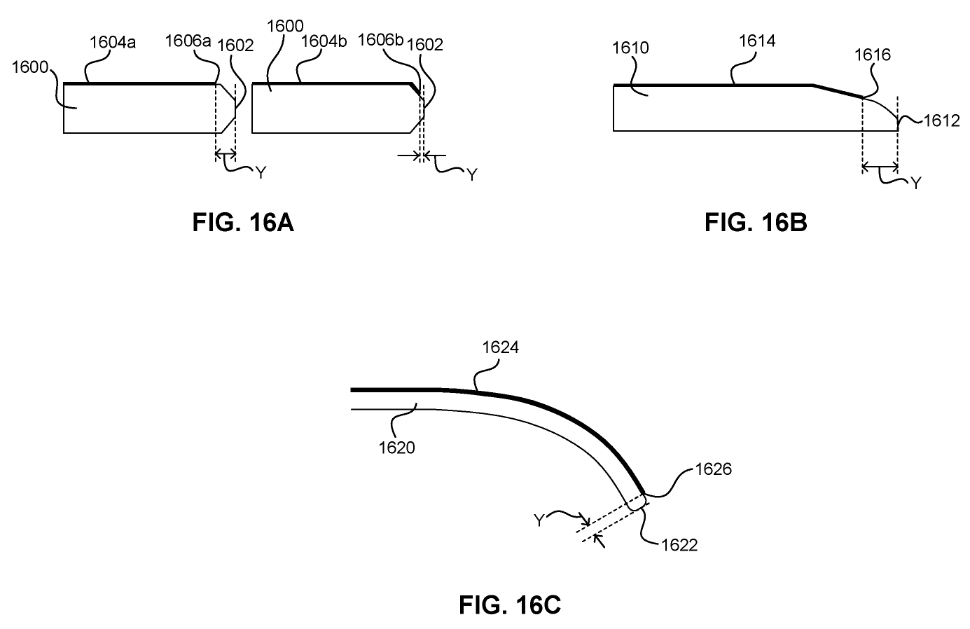

The masks discussed herein may be employed to mask a glass-based article (e.g., a cover glass) to protect one or more regions on its front surface (user-facing surface) and edges from coating during a coating process (e.g., during a vacuum deposition process). In some embodiments, a mask and a base plate may be used to fix and mask a glass-based article to protect portions of the glass-based article's front perimeter from coating during a coating process. In some embodiments, a mask having a contact portion and an eave portion dimensioned to facilitate formation of non-visible coating edges may be disposed over a glass-based article during a coating process to protect portions of the glass-based article's front perimeter from coating. In some embodiments, the eave portion may be tailored for a specific type of glass-based article (e.g., the 2D, 2.5D, and 3D covers glasses described in reference to FIGS. 16A-16C).

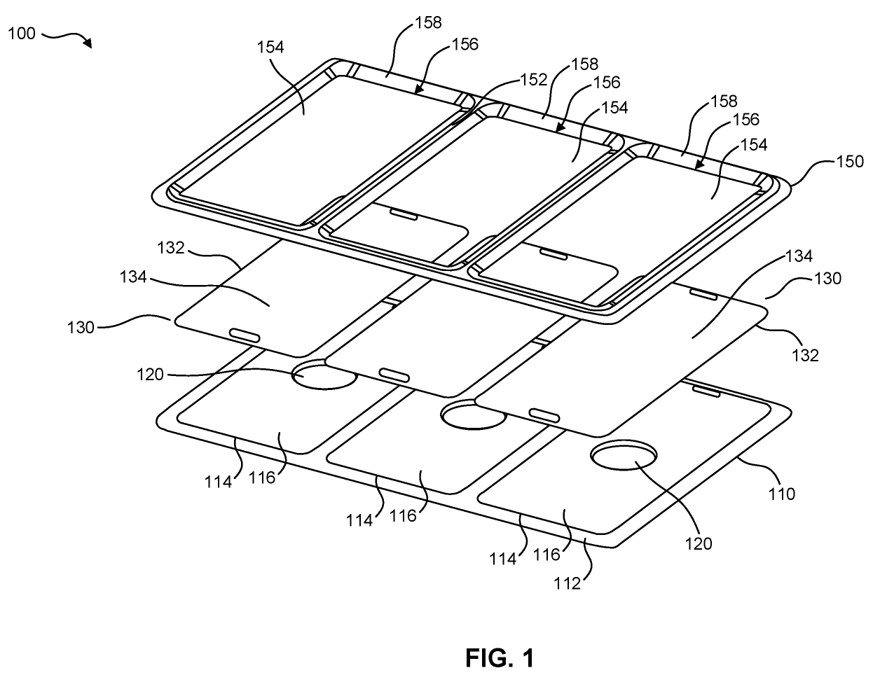

FIG. 1 shows an apparatus 100 for fixing and masking one or more cover glasses 130 according to some embodiments. Apparatus 100 may include a base plate 110 and a mask 150 to fix and mask perimeter portions of cover glass(es) 130 during a coating process. Base plate 110 may include a top surface 112 including one or more platforms 114 having a platform surface 116 configured (sized and shaped) to support a cover glass 130. In some embodiments, platform surfaces 116 may have a perimeter shape that is substantially the same as a perimeter edge 132 of a cover glass 130. In some embodiments, base plate 110 may include openings 120 formed in platforms 114 to facilitate removal of cover glasses 130 from base plate 110. For example, openings 120 may allow for application of an external pushing force on bottom surfaces of cover glasses 130 (e.g., by a robot or a human finger) to remove cover glasses 130 from base plate 110.

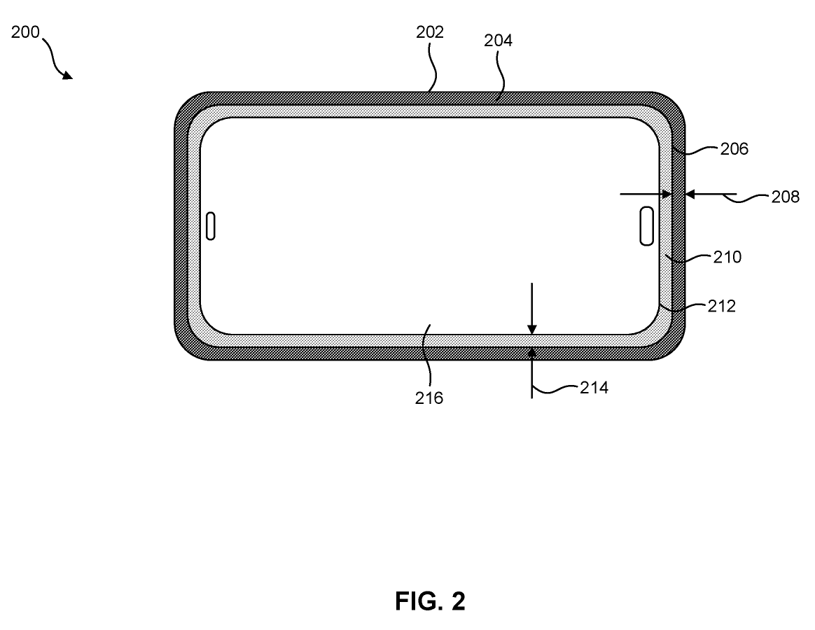

As shown in FIG. 1, mask 150 may include frame 152 with one or more apertures 154. Apertures 154 may include a periphery 156 with an eave 158. Eaves 158 may be the same as eave portions 356 and 456 discussed below. Apertures 154 allow for deposition of one or more coating layers through apertures onto top surfaces 134 on cover glasses 130. When mask 150 is disposed over cover glasses 130 eaves 158 extend over second annular perimeter portions on the top surfaces 134 of cover glasses 130 (e.g., second annular perimeter portion 210 in FIG. 2). By extending over second annular perimeter portions, eaves 158 facilitate the formation of a non-uniform coating layer thickness under eaves 158 and adjacent to the edge of the coating layer to form a coating layer with edges that are not visible to the naked eye.

As used herein, the term “not visible to the naked eye” means that a structure is not visible to a human, having 20/20 vision, under lighting conditions with an illuminance in the range of 1500 to 2000 lux (lumens per square meter).

When assembled about one or more cover glasses 130, mask 150 may releasably fix cover glass(es) 130 to base plate 110. In some embodiments, base plate 110 and/or mask 150 may be composed of a metallic material, for example aluminum, an aluminum alloy, or stainless steel. In some embodiments, base plate 110 and/or mask 150 may be composed of a metallic material coated with Polytetrafluoroethylene (Teflon).

FIG. 2 shows a cover glass 200 according to some embodiments. Cover glass 200 may include a perimeter edge 202 with a first annular perimeter portion 204 disposed inside and extending from perimeter edge 202. First annular perimeter portion 204 may extend from perimeter edge 202 to a first interior edge 206 located at a distance 208 from perimeter edge 202. In other words, distance 208 may define a width of first annular perimeter portion 204 around perimeter edge 202 of cover glass 200.

In some embodiments, distance 208 may be in the range 0.1 mm to 1.0 mm, including subranges. In other words, distance 208 may be 0.1 mm, 0.2 mm, 0.3 mm, 0.4 mm, 0.5 mm, 0.6 mm, 0.7 mm, 0.8 mm, 0.9 mm, or 1.0 mm or within any range having any two of these values as endpoints. In some embodiments, distance 208 may be in the range of 0.2 mm to 1.0 mm. In some embodiments, distance 208 may be in the range of 0.2 mm to 0.5 mm.

Cover glass 200 may also include a second annular perimeter portion 210 disposed inside and extending from first annular perimeter portion 204 (i.e., extending from interior edge 206 of first annular perimeter portion 204). Second annular perimeter portion 210 may extend from first annular perimeter portion 204 to a second interior edge 212 located at a distance 214 from first annular perimeter portion 204. In other words, distance 214 may define a width of second annular perimeter portion 210.

In some embodiments, distance 214 may be in the range 0.5 mm to 2.0 mm, including subranges. In other words, distance 214 may be 0.5 mm, 0.6 mm, 0.7 mm, 0.8 mm, 0.9 mm, 1.0 mm, 1.1 mm, 1.2 mm, 1.3 mm, 1.4 mm. 1.5 mm, 1.6 mm, 1.7 mm, 1.8 mm, 1.9 mm, 2.0 mm, 2.1 mm, 2.2 mm, 2.3 mm, 2.4 mm, or 2.5 mm or any range having any two of these values as endpoints. In some embodiments, the sum of distances 208 and 214 may be less than or equal to 3.0 mm.

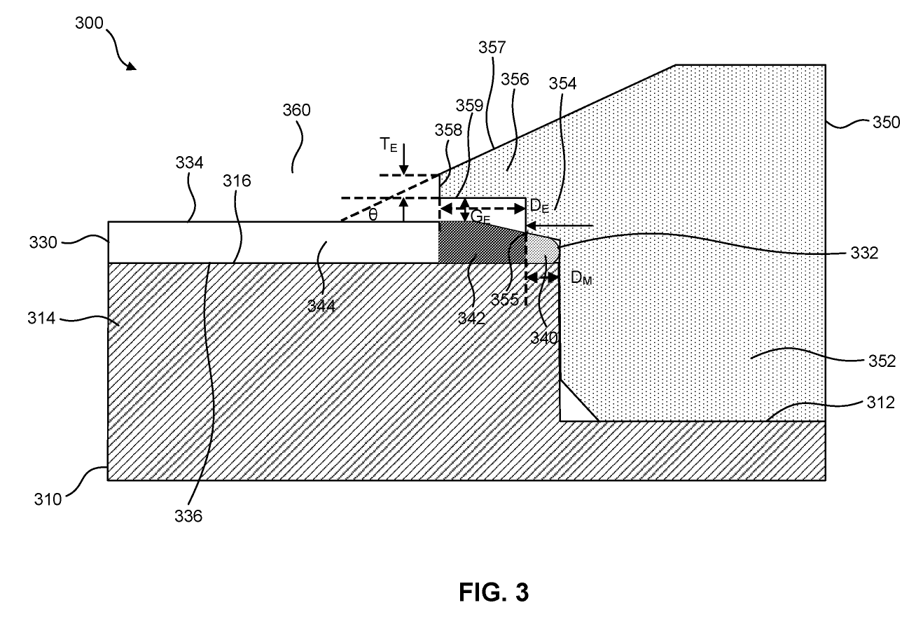

Cover glass 200 may also include an inner portion 216 disposed inside second annular perimeter portion 210. Inner portion 216 may be the portion of cover glass 200 over which a substantially uniform coating thickness will be deposited because this portion of cover glass 200 may be located directly below an aperture of a mask (e.g., an aperture 154 shown in FIG. 1) during a coating process. Second annular perimeter portion 210 of cover glass 200 is the portion of cover glass 200 over which a non-uniform coating thickness may be deposited because this portion of cover glass 200 may be located directly below an eave portion of a mask (e.g., eave portion 356 shown in FIG. 3). The edge of a coating layer may also be located in second annular portion of cover glass 200 because first annular perimeter portion 204 may be masked by a contact portion (e.g., contact portion 354 shown in FIG. 3), thereby inhibiting formation of a coating layer in first annular perimeter portion 204.

For purposes of this application, the portions and interior edges labeled in FIG. 2 may be used to define portions of a cover glass generally or may be used to define portions of a cover glass's surface (e.g., a cover glass's top, or user-facing, surface). The portions and interior edges labeled in FIG. 2 may be used to define portions of any cover glass discussed herein. Distances 208/214 may be the horizontal distances measured from perimeter edge 202 of cover glass 200 to a line intersecting respective interior edges 206/212 and extending parallel to perimeter edge 202. FIGS. 16A-16C show various examples of how to measure the distance “Y” from a perimeter edge of a cover glass to the edge of a coating layer on the cover glass. Distances 208 and 214 may be measured in the same fashion.

FIG. 3 shows an apparatus 300 for fixing and masking a cover glass 330 according to some embodiments. Cover glass 330 includes a perimeter edge 332, a top surface 334, and a bottom surface 336. Cover glass 330 also includes a first annular perimeter portion 340, a second annular perimeter portion 342, and an inner portion 344, which are defined in the same fashion as first annular perimeter portion 204, second annular perimeter portion 210, and inner portion 216 described above in regards to FIG. 2.

In some embodiments, cover class 330 may be disposed on a base plate 310 configured to support cover glass 330 during deposition of a coating layer. Base plate 310 may include a top surface 312 and a platform 314 the same as or similar to top surface 112 and platform 114 of base plate 110. In some embodiments, bottom surface 336 of cover glass 330 may be disposed on a platform surface 316 of platform 314 when cover glass 330 is disposed on base plate 310.

As shown in FIG. 3, apparatus 300 may also include a mask 350 configured to fix cover glass 330 on base plate 310 and configured to mask annular portions of cover glass 330. During use, base plate 310 and mask 350 may be assembled about cover glass 330 to releasably hold cover glass 330 in place during a coating deposition process. Mask 350 may include a frame 352, a contact portion 354, and an eave portion 356 comprising an edge 358 defining an aperture 360. In some embodiments, edge 358 of eave portion 356 may have a thickness T_{E} of 0.3 mm or less. A small thickness for T_{E}, for example 0.3 mm or less, may help avoid the formation of a moire pattern (also called a moire fringe) near and/or at the edges of a coating layer. The formation of a moire pattern may result in visual defects in the coating layer that are visible to the naked eye.

When mask 350 is disposed over cover glass 330 a coating layer may be deposited over cover glass 330 while one or more of the following five relationships exist between mask and cover glass. In some embodiments, all five of the relationships may exist. In some embodiments, at least four of the relationships may exist. In some embodiments, at least three of the relationships may exist. In some embodiments, at least two of the relationships may exist.

Unless stated otherwise, the dimensions T_{E}, as well as G_{E}, D_{E}, and D_{M}, and angle θ discussed below are expressed as values when mask 350 is at an elevated temperature, for example the time-averaged temperature over the time during which a coating layer is being deposited during a deposition process. In some embodiments, the time-averaged temperature during which a coating layer is being deposited during a deposition process may be in the range of 150 degrees C. to 250 degrees C. In some embodiments, these dimensions may be expressed as values at a time-averaged temperature in the range of 150 degrees C. to 250 degrees C., including subranges. In other words, the time averaged temperature may be 150 degrees C., 160 degrees C., 170 degrees C., 180 degrees C., 190 degrees C., 200 degrees C., 210 degrees C., 220 degrees C., 230 degrees C., 240 degrees C., or 250 degrees C. or within any range having any of these two values as endpoints. In some embodiments, these dimensions may be expressed as values when a mask is at a temperature of 250 degrees C. The value for a dimension at an elevated temperature may be calculated based on a measurement at room temperature, and knowledge of parameters such as temperature difference and coefficient of thermal expansion (CTE).

First, contact portion 354 of mask 350 contacts at least a portion of first annular perimeter portion 340 of cover glass 330. Contact between contact portion 354 and first annular perimeter portion 340, prevents formation of a coating layer in first annular perimeter portion 340. In some embodiments, at least a distal edge 355 of contact portion 354 contacts first annular perimeter portion 340 at the interior edge of first annular perimeter portion 340.

In some embodiments, contact portion 354 may contact the entire first annular perimeter portion 340 of top surface 334 of cover glass 330. In such embodiments, contact portion 354 may include a shape the corresponds to the shape of the surface profile of top surface 334 in first annular perimeter portion 340 of cover glass 330. As shown for example in FIG. 3, contact portion 354 may extend from frame 352 of mask 350 to a distance D_{M} from frame 352. Distance D_{M} may be equal to any of the values/ranges discussed herein for distance 208. In some embodiments, distance D_{M} may be the same as the width of first annular perimeter portion of cover glass 330 (i.e., equal to distance 208) such that contact portion 354 extends over the entire first annular perimeter portion 340 of cover glass 330.

Second, eave portion 356 extends over second annular perimeter portion 342 of cover glass 330. In some embodiments, eave portion 356 may extend over the entire second annular perimeter portion 342 of cover glass 330. In such embodiments, edge 358 of eave portion 356 may be disposed directly above the interior edge of second annular perimeter portion 342. Eave portion 356 may extend from contact portion 354 to a distance D_{E} from contact portion 354. Distance D_{E} may be equal to any of the values/ranges discussed herein for distance 214. In some embodiments, D_{E} may be the same as the width of second annular perimeter portion 342 of cover glass 330 (i.e., equal to distance 214) such that eave portion 356 extends over the entire second annular perimeter portion 342 of cover glass 330.

Third, aperture 360 is disposed over inner portion 344 of cover glass 330. Aperture 360 allows coating particles to deposit on inner portion 344 of top surface 334 during a coating process. Coating particles that pass through aperture 360 with little to no interference from mask 350 may form a coating layer having a generally uniform thickness on inner portion 344 of top surface 334. However, the path of coating particles that travel near eave portion 356 of mask 350 will be affected by eave portion 356. Eave portion 356 shadows second annular perimeter portion 342 and controls the amount of coating particles that may be deposited under it (this may be referred to as a “shadowing effect”). This will cause deposition of a portion of coating layer under eave portion 356 having a non-uniform thickness (e.g., a gradually decreasing thickness). The dimensions and location of eave portion 356 relative to top surface 334 of cover glass 330 may be tailored to produce a desired non-uniform thickness profile of a coating layer under eave portion 356 on top surface 334.

Fourth, an upper surface 357 of eave portion 356 has a positive slope (θ) extending away from edge 358 (and toward the right side of FIG. 3, i.e., away from aperture 360) of eave portion 356 and measured relative to a plane (e.g., a plane on top surface 334) of cover glass 300. In some embodiments, θ may be 30 degrees or less. In some embodiments, θ may be measured relative to bottom surface 359 of eave portion 356. An angle for θ equal to 30 degrees or less helps avoid the formation of a moire pattern (also called a moire fringe) near and/or at the edges of a coating layer, which may result in visual defects in the coating layer.

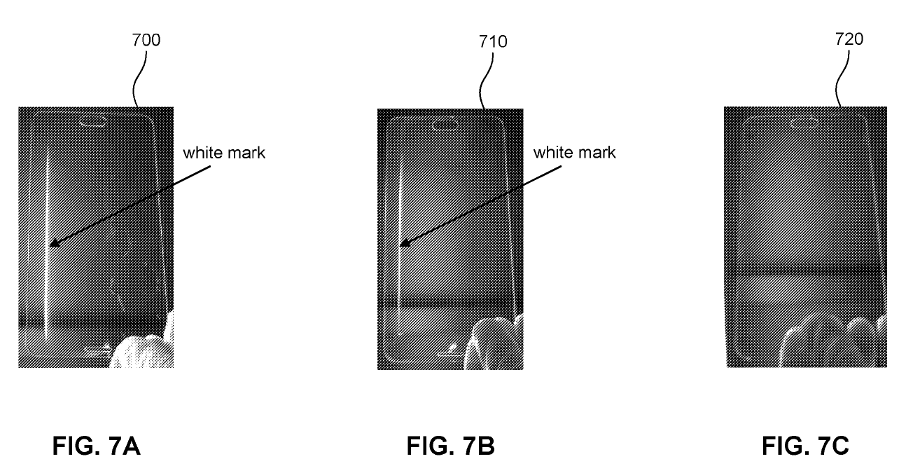

Fifth, a bottom surface 359 of eave portion 356 is disposed at a distance G_{E} that is least 150 microns above second annular perimeter portion 342 of top surface 334 of cover glass 330. In some embodiments, bottom surface 359 of eave portion 356 at edge 358 may be disposed at least 150 microns above second annular perimeter portion 342 of top surface 334. In such embodiments, bottom surface 359 of eave portion 356 at edge 358 may be disposed at least 150 microns above the interior edge of second annular perimeter portion 342 of cover glass 330. Locating bottom surface 359 of eave portion 356 at least 150 microns above top surface 334 may facilitate the formation of a non-uniform coating thickness under the eave and prevent the formation of a visible white mark in a coating layer (see white marks in FIGS. 7A and 7B).

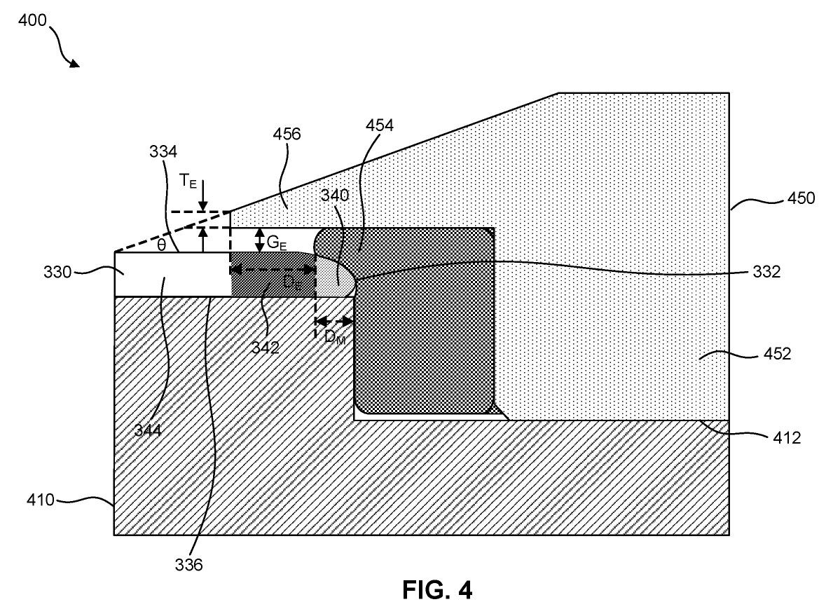

FIG. 4 shows an apparatus 400 for fixing and masking cover glass 330 according to some embodiments. Apparatus 400 may include a base plate 410 the same as or similar to base plate 310. Apparatus 400 may also include a mask 450 having a frame 452, elastic contact portion 454, and an eave portion 456 having the same dimensions and relationships with cover glass 330 as decried above with regards to mask 350. Similar to contact portion 354, elastic contact portion 454 may be configured to contact at least a portion of top surface 334 of cover glass 330. In some embodiments, the material of elastic contact portion 454 may be selected such that is capable of conforming with the shape of the portion of top surface 334 that it contacts. Elastic contact portion 454 may be composed, in whole or in part, of an elastic material. The elastic material may be, but is not limited to, a perflouro-elastomer or polydimethylsiloxane (PDMS).

Elastic contact portion 454 may help create a seal between mask 450 and top surface 334 of cover glass 330. In some embodiments, elastic contact portion 454 may help prevent leakage of a coating layer between elastic contact portion 454 and top surface 334 during deposition. In some embodiments, elastic portion 454 may create a seal between mask 450 and top surface 334 of cover glass that prevents leakage of a coating layer between elastic contact portion 454 and top surface 334 during deposition. Such leakage of a coating layer can cause abnormal deposition of the coating layer at the edge of coating layer, which may result in visual defects at the edge. Elastic contact portion 454 may also help reduce the machine tolerance required to make a seal between mask 450 and cover glass 330 without damaging cover glass 330.

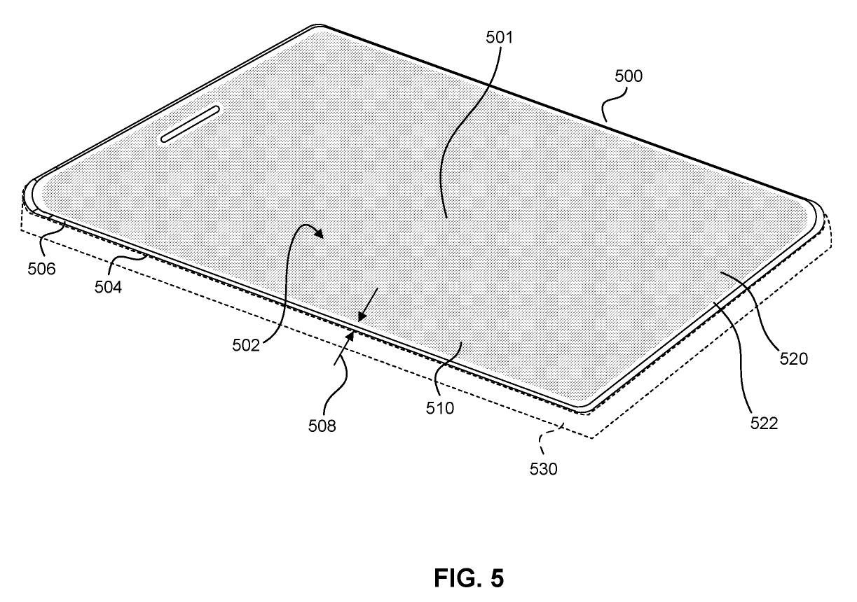

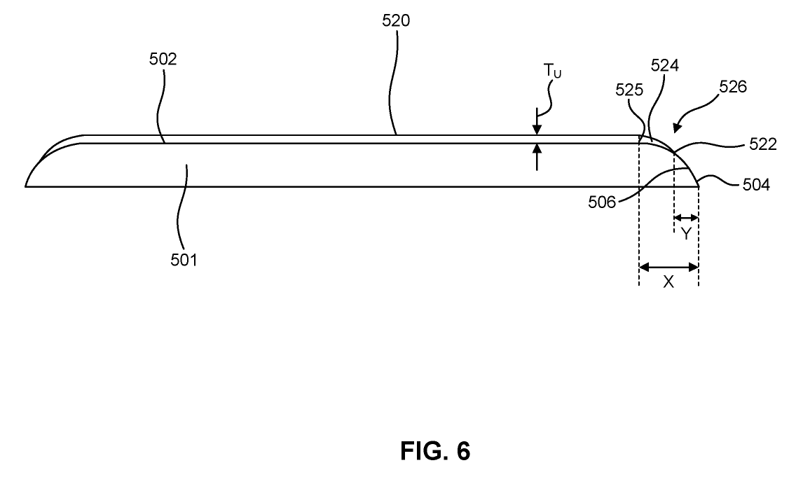

The relationships between cover glass 330 and portions of masks 350 and 450, and the dimensions of eave portions 356/456 discussed above may produce a coating layer on top surface 334 of cover glass 330 with a non-uniform coating thickness in second annular perimeter portion 342 of cover glass 330. In some embodiments, the non-uniform coating thickness may gradually decrease in thickness when moving away from inner portion 344 and towards first annular perimeter portion 340 of cover glass 330. FIGS. 5 and 6 show an exemplary coating layer 520 having a non-uniform thickness region on a cover glass 500 according to some embodiments.

Cover glass 500 includes a body 501, a top surface 502 and a perimeter edge 504. Top surface 502 of cover glass 500 includes a perimeter portion 506 devoid of coating layer 520 and a central portion 510 that is coated with coating layer 520. In other words, coating layer 520 may be disposed on central portion 510 but not on perimeter portion 506. Cover glass 500 may be a 2D, 2.5D, or 3D cover glass.

Perimeter portion 506 includes at least a portion of perimeter edge 504 and a region extending from perimeter edge 504 to a distance 508 from perimeter edge 504 on top surface 502. In some embodiments, perimeter portion 506 may include the entire perimeter edge 504 of cover glass 500 and a region extending from perimeter edge 504 to a distance 508 from perimeter edge 504 on top surface 502. In other words, perimeter portion 506 may be an area in the shape of a peripheral border on top surface 502 of cover glass 500.

Distance 508 may define the width of perimeter region 506 around perimeter edge 504 of cover glass 500. In some embodiments, distance 508 may be in the range of 0.1 mm to 1.0 mm, including subranges. In other words, distance 508 may be 0.1 mm, 0.2 mm, 0.3 mm, 0.4 mm, 0.5 mm, 0.6 mm, 0.7 mm, 0.8 mm, 0.9 mm, or 1.0 mm or within any range having any of these two values as endpoints. In some embodiments, distance 508 may be in the range of 0.2 mm to 1.0 mm. In some embodiments, distance 508 may be in the range of 0.2 mm to 0.5 mm.

In some embodiments, distance 508 may be the same as the width of a first annular perimeter portion of cover glass 500 (i.e., the same as distance 208). In such embodiments, coating layer 520 may cover the entire second annular perimeter portion of cover glass 500. In other words, a perimeter edge 522 of coating layer 520 may be located at the first interior edge of the first annular perimeter portion of cover glass 500. In some embodiments, distance 508 may be greater than distance 208. In such embodiments, coating layer 520 may cover portions of second annular perimeter portion of cover glass 500, including less than the entire second annular perimeter portion. In such embodiments, perimeter edge 522 of coating layer 520 may be located in the second annular perimeter portion of cover glass 500. The dimensions of eave portions 356/456 may be tailored to provide a coating layer 520 with a perimeter edge 522 located at a desired distance 508 from perimeter edge 504 of cover glass.

As shown for example in FIG. 6, coating layer 520 may include a non-uniform coating thickness region 524 at the periphery 526 of coating layer 520 near perimeter edge 522. In some embodiments, non-uniform coating thickness region 524 may include a coating profile that gradually decreases in thickness when moving from central portion 510 towards perimeter edge 522 (and perimeter portion 506). As used herein, the term “gradually” means a change in thickness having an average slope of no greater than three over a distance equal to at least 33% of the total width of the non-uniform coating thickness region, measured for any portion of the non-uniform coating thickness region having a width equal to at least 33% of the region's total width. In other words, for any portion of the coating profile having a width equal to at least 33% of the non-uniform coating thickness region's total width, the thickness of the coating profile at the start of that portion and the end of that portion does not differ by more than 3 times the width of that portion.

Non-uniform coating thickness region 524 may include a maximum thickness 525 located X mm from perimeter edge 504 and a minimum thickness located at perimeter edge 522 and Y mm from perimeter edge 504. Maximum thickness 525 may be the same as the thickness of the portion of coating layer 520 having uniform thickness. In some embodiments, X may be in the range of 0.5 mm to 3.0 mm, including subranges. In other words, X may be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, or 3.5 mm or within any range having any two of these values as endpoints. In some embodiments, X may be equal to the sum of distances 208 and 214 (i.e., the sum of the widths of first annular perimeter portion and second annular perimeter portion of cover glass 500).

In some embodiments, Y may be in the range of 0.1 mm to 1.0 mm, including subranges. In other words, Y may be 0.1 mm, 0.2 mm, 0.3 mm, 0.4 mm, 0.5 mm, 0.6 mm, 0.7 mm, 0.8 mm, 0.9 mm, or 1.0 mm or within any range having any of these two values as endpoints. In some embodiments, Y may be equal to distance 208 (i.e. the width of first annular perimeter portion of cover glass 500). In some embodiments, Y may be greater than distance 208. Distance Y is referred to as distance 508 in FIG. 5.

The dimensions G_{E} and D_{E} of eave portions 356/456 may be tailored to control distances X and Y by controlling the amount of coating particles that may be deposited in second annular perimeter portion of cover glass 500. For example, dimensions G_{E} and D_{E} may be tailored to ensure that perimeter edge 522 of coating layer is located in second annular perimeter portion of cover glass 500. In such embodiments, this will ensure that perimeter edge 522 is spaced apart from the contact portion 354/454 of mask 350/450. If perimeter edge 522 is spaced apart from contact portion 354/454, the possibility of coating leakage between top surface 502 and contact portion 354/454 may be eliminated. Further, if perimeter edge 522 is spaced apart from contact portion 354/454 the possibility of forming a uniform perimeter edge 522 (i.e., an edge formed at about a 90 degree angle (e.g., 85 degrees to 95 degrees) relative to top surface 502) may be eliminated.

In some embodiments, non-uniform coating thickness region 524 on cover glass 500 may not be visible to the naked eye on a top surface of a cover glass. In some embodiments, non-uniform coating thickness region 524 may be devoid of a white mark (see FIG. 7C showing no white mark, and compare with FIGS. 7A and B wherein a white mark is present) caused by defects in the coating profile of non-uniform coating thickness region 524. In some embodiments, non-uniform coating thickness region 524 may have a surface profile that decreases in thickness when moving from central portion 510 towards perimeter portion 506 and that lacks zero-order and first-order discontinuities.

Zero-order and first-order discontinuity are a measure of smoothness for a curve or surface. Zero-order discontinuity means that two curve/surface sections do not meet at their boundary. In other words, zero-order discontinuity means that a first curve/surface and a second curve/surface are not continuous, but rather are separated at their boundary (e.g., by a vertical step). First-order discontinuity means that the first parametric derivatives of two curve/surface sections are not proportional at their boundary. In other words, first-order discontinuity means that, at a point of intersection between a first curve/surface and a second curve/surface, the first derivatives for the first curve/surface and the second curve/surface are not continuous. Zero-order and first-order discontinuities may be visible to the naked eye on a cover glass.

In some embodiments, cover glass 500 may be included on an article 530 (shown in broken lines in FIG. 5 for illustration purposes) to protect portions of article 530, for example the display components of article 530. Article 530 may be, but is not limited to, a mobile phone, a tablet computer device, and a wearable device (e.g., a watch).

In some embodiments, the portion of coating layer 520 having a uniform thickness may have a thickness T_{U} in the range of 1.0 micron to 3.0 microns. In some embodiments, thickness T_{U} may be about 2.0 microns (e.g., 1.5 microns to 2.5 microns). In some embodiments, coating layer 520 may be a scratch resistant coating layer. Exemplary materials used in the scratch resistant coating layer may include an inorganic carbide, nitride, oxide, diamond-like material, or a combination thereof.

In some embodiments, the scratch resistant coating layer may include a multilayer structure of Aluminum Oxynitride (AlON) and Silicon dioxide (SiO₂). In some embodiments, the scratch resistant coating layer may include a metal oxide layer, a metal nitride layer, a metal carbide layer, a metal boride layer or a diamond-like carbon layer. Example metals for such an oxide, nitride, carbide or boride layer include boron, aluminum, silicon, titanium, vanadium, chromium, yttrium, zirconium, niobium, molybdenum, tin, hafnium, tantalum, and tungsten. In some embodiments, the coating layer may include an inorganic material. Non-limiting example inorganic layers include aluminum oxide and zirconium oxide layers.

In some embodiments, the scratch resistant coating layer may include a scratch resistant coating layer as described in U.S. Pat. No. 9,328,016, issued on May 3, 2016, which is hereby incorporated by reference in its entirety by reference thereto. In some embodiments, the scratch resistant coating layer may include a silicon-containing oxide, a silicon-containing nitride, an aluminum-containing nitride (e.g., AN and AlₓSi_{y}N), an aluminum-containing oxy-nitride (e.g., AlOₓN_{y} and SiᵤAlᵥOₓN_{y}), an aluminum-containing oxide or combinations thereof. In some embodiments, the scratch resistant coating layer may include transparent dielectric materials such as SiO₂, GeO₂, Al₂, O₃, Nb₂O₅, TiO₂, Y₂O₃ and other similar materials and combinations thereof In some embodiments, the scratch resistant coating layer may include a scratch resistant coating layer as described in U.S. Pat. No. 9,110,230, issued on Aug. 18, 2015, which is hereby incorporated by reference in its entirety by reference thereto. In some embodiments, the scratch resistant coating layer may include one or more of AN, Si₃N₄, AlOₓN_{y}, SiOₓN_{y}, Al₂O₃, SiₓC_{y}, SiₓO_{y}C_{z}, ZrO₂, TiOₓN_{y}, diamond, diamond-like carbon, and SiᵤAlᵥOₓN_{y}. In some embodiments, the scratch resistant coating layer may include a scratch resistant coating layer as described in U.S. Pat. No. 9,359,261, issued on Jun. 7, 2016, or U.S. Pat. No. 9,335,444, issued on May 10, 2016, both of which are hereby incorporated by reference in their entirety by reference thereto.

In some embodiments, coating layer 520 may be an anti-reflection coating layer. Exemplary materials suitable for use in the anti-reflective coating layer include: SiO2, Al₂O₃, GeO₂, SiO, AlOₓN_{y}, AlN, SiNₓ, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, and other materials cited above as suitable for use in a scratch resistant layer. An anti-reflection coating layer may include sub-layers of different materials.

In some embodiments, the anti-reflection coating layer may include a hexagonally packed nanoparticle layer, for example but not limited to, the hexagonally packed nanoparticle layers described in U.S. Pat. No. 9,272,947, issued Mar. 1, 2016, which is hereby incorporated by reference in its entirety by reference thereto In some embodiments, the anti-reflection coating layer may include a nanoporous Si-containing coating layer, for example but not limited to the nanoporous Si-containing coating layers described in WO2013/106629, published on Jul. 18, 2013, which is hereby incorporated by reference in its entirety by reference thereto. In some embodiments, the anti-reflection coating may include a multilayer coating, for example, but not limited to the multilayer coatings described in WO2013/106638, published on Jul. 18, 2013; WO2013/082488, published on Jun. 6, 2013; and U.S. Pat. No. 9,335,444, issued on May 10, 2016, all of which are hereby incorporated by reference in their entirety by reference thereto.

In some embodiments, coating layer 520 may be an easy-to-clean coating layer. In some embodiments, the easy-to-clean coating layer may include a material selected from the group consisting of fluoroalkylsilanes, perfluoropolyether alkoxy silanes, perfluoroalkyl alkoxy silanes, fluoroalkylsilane-(non-fluoroalkylsilane) copolymers, and mixtures of fluoroalkylsilanes. In some embodiments, the easy-to-clean coating layer may include one or more materials that are silanes of selected types containing perfluorinated groups, for example, perfluoroalkyl silanes of formula (R_{F})_{y}Si_{X4-y}, where RF is a linear C6-C₃₀ perfluoroalkyl group, X═CI, acetoxy, —OCH₃, and —OCH₂CH₃, and y=2 or 3. The perfluoroalkyl silanes can be obtained commercially from many vendors including Dow-Corning (for example fluorocarbons 2604 and 2634), 3MCompany (for example ECC-1000 and ECC-4000), and other fluorocarbon suppliers such as Daikin Corporation, Ceko (South Korea), Cotec-GmbH (DURALON UltraTec materials) and Evonik. In some embodiments, the easy-to-clean coating layer may include an easy-to-clean coating layer as described in WO2013/082477, published on Jun. 6, 2013, which is hereby incorporated by reference in its entirety by reference thereto. In some embodiments, cover glass 500 may include multiple coating layers 520.

FIGS. 7A-7C illustrate the effect that eave portions positioned at different distances G_{E} have on the visibility of a coating layer on a cover glass. FIG. 7A shows a cover glass 700 having a coating layer deposited using a mask having an eave portion positioned 50˜60 microns above the top surface of un-coated cover glass 700 (i.e., a G_{E} of 50˜60 microns). FIG. 7B shows a cover glass 710 having a coating layer deposited using a mask having an eave portion positioned 100˜120 microns above the top surface of un-coated cover glass 710. FIG. 7C shows a cover glass 720 having a coating layer deposited using a mask having an eave portion positioned 150˜180 microns above the top surface of un-coated cover glass 720.

Each cover glass 700, 710, and 720 was coated with the same coating layer material using a meta mode sputter process. An Al/Si target was used for the sputtering process. The pressure in the sputtering chamber was 1˜0.05 Pascals (Pa). The medium frequency power for the sputter process was 8˜9 kilowatts (kw). And the Argon flow on the target zone was 120˜180 standard cubic centimeters per minute (sccm). Each cover glass 700, 710, and 720 was coated using an eave portion made from glass and having an edge thickness of 0.5 mm.

As shown in FIGS. 7A and 7B, a G_{E} of 50˜60 microns and a G_{E} of 100˜120 microns resulted in the formation of a white mark along the edge of the coating layer deposited on cover glasses 700 and 710. This white mark formed directly below the edge of the eave portion used during the coating of cover glasses 700 and 710. In contrast, as shown in FIG. 7C, a G_{E} of 150˜180 microns resulted in a coating layer without this white mark.

The photographs shown in FIGS. 7A-7C were taken with a Nikon D40 digital camera in an inspection booth having an illuminance of 1500 lux. The presence of the white marks on cover glasses 700 and 710 under typical indoor ambient lighting conditions may be aesthetically undesirable and districting for a user of an electronic device including cover glasses 700 and 710.

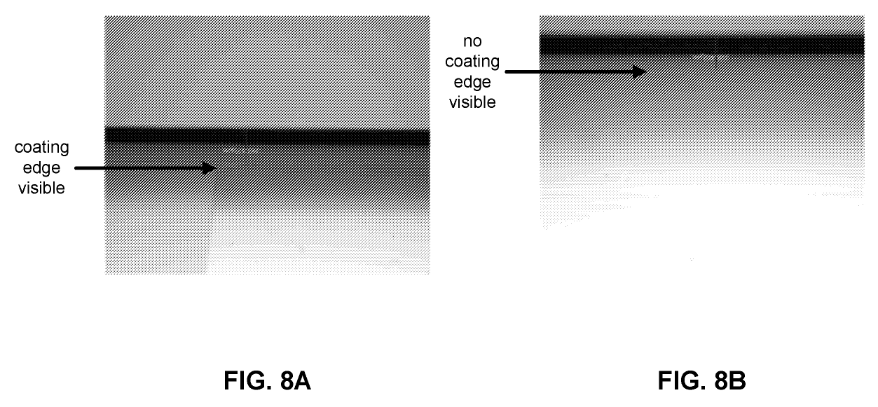

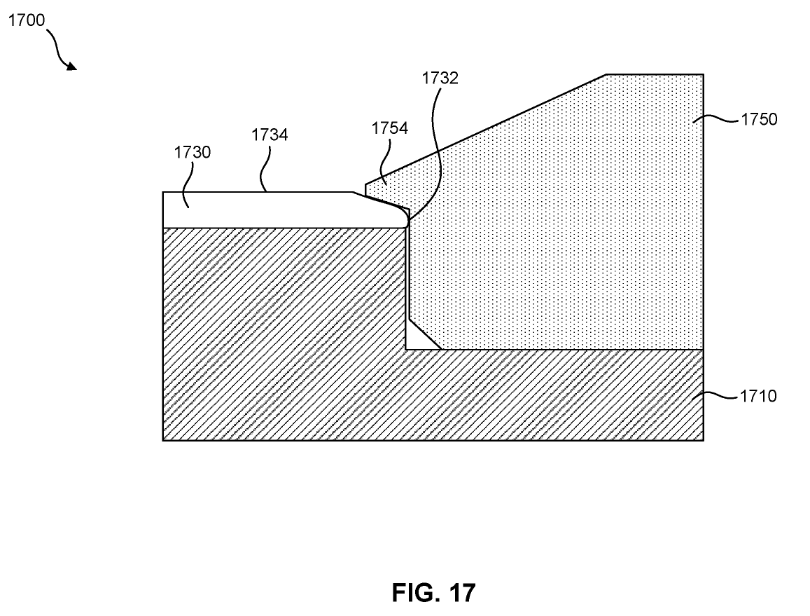

FIGS. 8A and 8B show a comparison of a coating layer having an edge formed at a right angle (i.e., a uniform thickness) on a cover glass (FIG. 8A) and a coating layer having an edge and a non-uniform thickness region at the periphery of the coating layer adjacent to the edge (FIG. 8B). The coating layer shown in FIG. 8A may be formed using a contact mask like the one shown in FIG. 17. The coating layer shown in FIG. 8B may be formed using a mask with an eave portion as discussed herein. As shown in FIG. 8B, the non-uniform coating thickness of a coating layer formed using a mask with an eave portion as discussed herein is not visible under a microscope at 100× magnification.

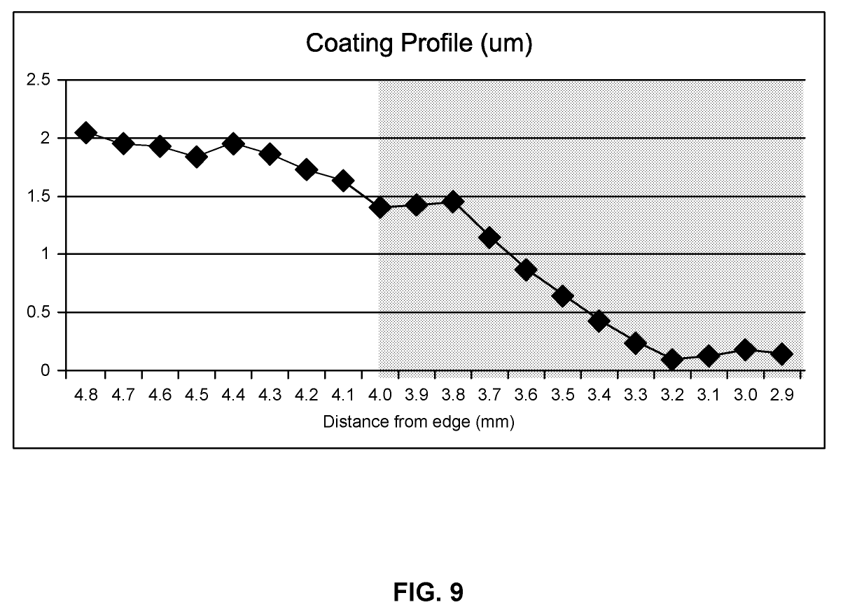

FIG. 9 shows a coating profile for a coating layer according to some embodiments. The coating layer profiled in FIG. 9 was deposited on a cover glass using an eave portion having a D_{E} of 4.0 mm and a G_{E} of 0.3 mm. A D_{E} of 4.0 mm was used to ensure that the entire coating layer was deposited on a flat surface of the cover glass for ease in measuring the coating layer's profile.

FIG. 9 is a plot of coating thickness in microns (on the Y-axis) versus distance in mm (on the X-axis) from the perimeter edge of the cover glass. In FIG. 9, the edge of the eave portion is shown at a distance 4.0 mm, and the portion of the cover glass under the eave portion is shown as shaded in grey. As shown in FIG. 9, the thickness of the coating layer begins to noticeably decrease from about 0.2 mm to about 0.3 mm inside the edge of the eave portion. This is due to the eave portion controlling the amount of coating particles that may be deposited underneath it (i.e., in the space defined by G_{E} and D_{E}). FIG. 9 also shows the coating thickness decreasing slightly starting at about 0.3 mm to 0.4 mm outside the edge of the eave portion due to the influence of eave portion on the coating particles depositing in that area. The thickness underneath the eave portion gradually decreases until it reaches a minimum of approximately 0.1 microns at a position of about 0.8 mm from the edge of the eave portion. The coating profile shown in FIG. 9 is not visible to the naked eye on a curved edge of a 2.5D cover glass and does not include a white mark (see FIG. 7C).

In some embodiments, the dimensions D_{E} and G_{E} of an eave portion (e.g., eave portion 356) along different sides of a cover glass may be tailored to control distance X and/or Y on different sides of a cover glass (e.g., cover glass 500). In some embodiments, the dimension D_{E} along different sides of a cover glass may be tailored such that distance X and/or Y is the same along the entire perimeter of the cover glass. In some embodiments, the dimension D_{E} along different sides of a cover glass may be tailored such that distance X and/or Y is different along different sides of the cover glass. In some embodiments, the dimension G_{E} on along different sides of a cover glass may be tailored such that distance X and/or Y is the same along the entire perimeter of the cover glass. In some embodiments, the dimension G_{E} along different sides of a cover glass may be tailored such that distance X and/or Y is different along different sides of the cover glass.

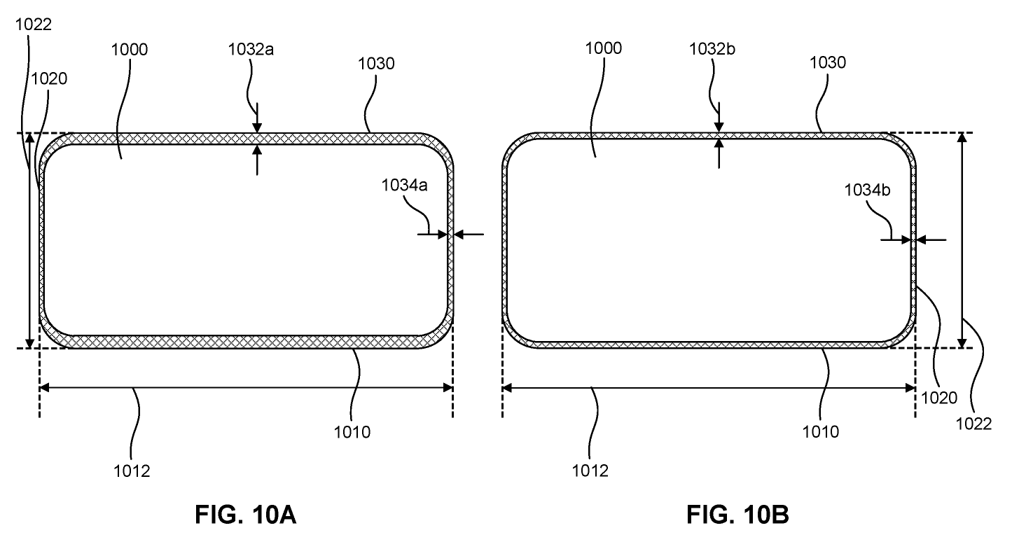

As illustrated in FIGS. 10A and 10B, the dimension D_{E} along the long sides 1010 (having a length measured in a first direction 1012) and short sides 1020 (having a length measured in a second direction 1022 perpendicular to first direction 1012) of a cover glass 1000 may change depending on temperature. D_{E} may change due to linear thermal expansion of the material used to make a mask. D_{E} along long sides 1010 in FIGS. 10A and 10B is labeled as 1032a/b. D_{E} along short sides 1020 in FIGS. 10A and 10B is labeled as 1034a/b.

FIG. 10A shows an eave 1030 extending over a periphery of cover glass 1000 at an elevated temperature (e.g., over 200° C.) during a coating process. FIG. 10B shows eave 1030 extending over the periphery of a cover glass 1000 at room temperature. As shown in FIG. 10B, eave 1030 may extend over the periphery of cover glass 1000 along long sides 1010 by a distance 1032b and may extend over the periphery of cover glass 1000 along short sides 1020 by a distance 1034b. At room temperature, distance 1032b and 1034b may be the same.

However, at elevated temperature, eave 1030 may extend over the periphery of cover glass 1000 along long sides 1010 by a distance 1032a and may extend over the periphery of cover glass 1000 along short sides 1020 by a distance 1034a. In some embodiments, distance 1032a may be larger than distance 1032b due to linear thermal expansion of eave 1030. In some embodiments, distance 1034a may be larger than distance 1034b due to thermal expansion of eave 1030. In some embodiments, the difference between 1032b and 1032a may be greater than the difference between 1034b and 1034a due to differing degrees of thermal expansion of eave in first direction 1012 and second direction 1022 resulting from the rectangular shape of eave 1030.

In some embodiments, it may be desirable to deposit a coating layer having an edge located further away from the perimeter edges of cover glass 1000 along long sides 1010 than the perimeter edges of cover glass along short sides 1020 (i.e., distance Y being larger along long sides 1010 than along short sides 1020). In some embodiments, this may be accomplished by using an eave having a D_{E} along short sides 1020 of cover glass 1000 that is equal to or smaller than the D_{E} along long sides 1010 of cover glass 1000 (e.g., the eave dimensions shown in FIG. 10B with 1032b being equal to 1034b). The linear thermal expansion of eave 1030 at elevated temperature during coating will cause the deposition of such a coating layer. In such embodiments, at room temperature, the eave 1030 may extend over the second annular perimeter portion of long sides 1010 of cover glass 1000 by a first distance and extend over the second annular perimeter portion of short sides 1020 of cover glass 1000 by a second distance that is the same or smaller than the first distance.

In some embodiments, it may be desirable to deposit a coating layer having an edge located the same distance from the perimeter edge of cover glass 1000 along the entire perimeter of cover glass 1000 (i.e., distance Y being the same along the entire perimeter of cover glass 1000). In some embodiments, this may be accomplished by using an eave having a D_{E} along short sides 1020 of cover glass 1000 that is larger than the D_{E} along long sides 1010 of cover glass 1000 at room temperature (e.g., the opposite of the relative eave dimensions shown in FIG. 10A), to compensate for the thermal expansion. In such embodiments, at room temperature, eave 1030 may extend over the second annular perimeter portion of long sides 1010 of cover glass 1000 by a first distance and extend over the second annular perimeter portion of short sides 1020 of cover glass 1000 by a second distance that is greater than the first distance (i.e., the first distance is less than the second distance).

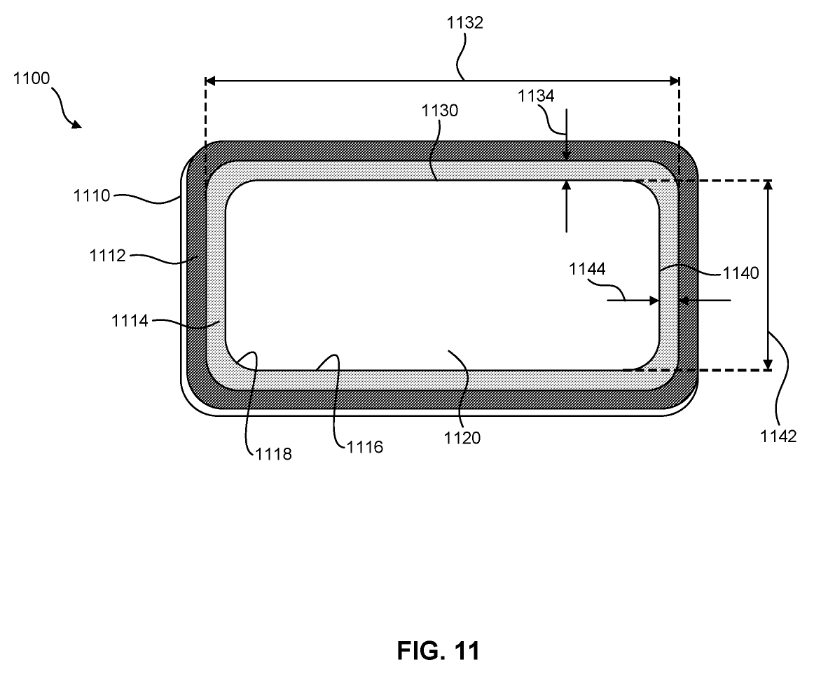

FIG. 11 shows a bottom view of a mask 1100 according to some embodiments. Mask 1100 includes a frame 1110 and a contact portion 1112 configured to contact a first annular perimeter portion of a cover glass. Contact portion 1112 may be the same as or similar to contact portions 354/454 discussed above in regards to FIGS. 3 and 4. Mask 1100 also includes an eave portion 1114 configured to extend over a second annular perimeter portion of a cover glass. Eave portion 1114 includes an edge 1116 defining an aperture 1120 and may be the same as or similar to eave portions 356/456 discussed above in regards to FIGS. 3 and 4. For example, edge 1116 may have a thickness of 0.3 mm or less, a bottom surface of eave portion 1114 at edge 1116 may be configured to be located at least 150 microns above an interior edge of a second annular perimeter portion of a cover glass, and an upper surface of eave portion 1114 may have a slope of 30 degrees or less measured relative to the bottom surface of eave portion 1114.

Eave portion 1114 may include two long sides 1130 having a length measured in a first direction 1132 and two short sides 1140 having a length measured in a second direction 1142 perpendicular to first direction 1132. Long sides 1130 of eave portion 1114 extend from contact portion 1112 by a first distance 1134 and short sides 1140 of eave portion 1114 extend from contact portion 1112 by a second distance 1144. In some embodiments, at room temperature, first distance 1134 may be different from second distance 1144. For example, first distance 1134 may be less than second distance 1144 to compensate for thermal expansion of mask 1100 and to create a coating layer having a perimeter edge located the same distance from the perimeter edge of a cover glass along the entire perimeter of the cover glass. In other words, a coating layer where the distance Y is the same along the entire perimeter of the cover glass.

In some embodiments, first distance 1134 may be 1%, 5%, 10%, 20%, 30%, 40%, 50%, 60%, 70%, 80%, 90%, or 100%, or within any range having any two of these values as endpoints, less than second distance 1144 to compensate for thermal expansion of mask 1100 and to create a coating layer having a perimeter edge located the same distance from the perimeter edge of a cover glass along the entire perimeter of the cover glass.

In some embodiments, first distance 1134 may be the same as second distance 1144. In such embodiments, mask 1100 may be used to deposit a coating layer having a perimeter edge located further away from the perimeter edges of a cover glass along the long sides of the cover glass than the perimeter edges of cover glass along the short sides of the cover glass. In other words, a coating layer where the distance Y is bigger along the long sides of the cover glass than the short sides of the cover glass. In some embodiments, first distance 1134 and second distance 1144 may be tailored to deposit a coating layer having a perimeter edge located closer the perimeter edges of a cover glass along the long sides of the cover glass than the perimeter edges of cover glass along the short sides of the cover glass. In other words, a coating layer where the distance Y is smaller along the long sides of the cover glass than the short sides of the cover glass.

In some embodiments, aperture 1120 of mask 1100 may have a rectangular shape defined by edge 1116. In some embodiments, aperture 1120 may have a different shape, for example but not limited to, a square shape or circular shape. In embodiments include a shape having corners, like corners 1118 shown in FIG. 11, the corners may be formed at right angles (i.e., where a long side and a short side come together to form a 90 degree angle) or the corners may be formed with a desired radius of curvature (e.g., a radius of curvature matching the radius of curvature of a cover glass) to be coated.

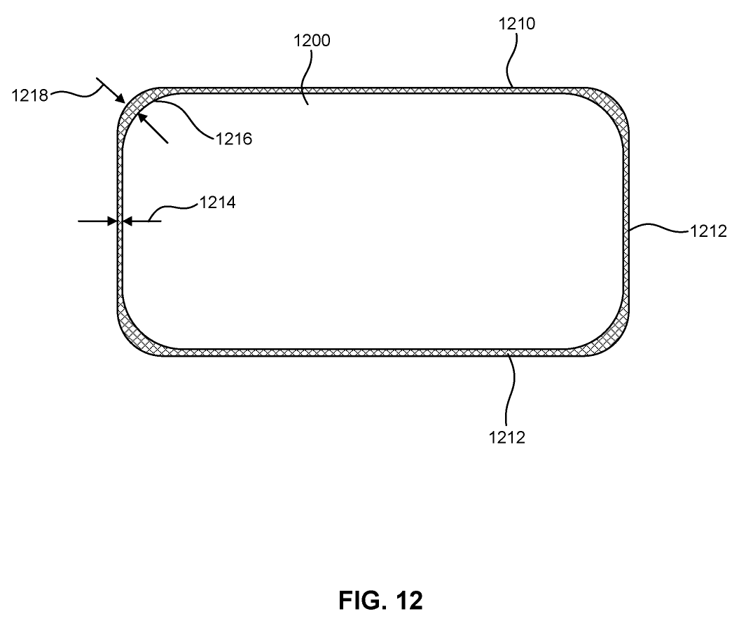

In some embodiments, the radius of curvature of the corners of an aperture may be different than the radius of curvature of the corners of a cover glass to be coated. In such an embodiment, the masking distance around the corners of a cover glass may be larger than the masking distance along the sides of the cover glass. For example, as shown in FIG. 12, an eave 1210 may extend over the sides 1212 of a cover glass 1200 by a distance 1214 and extend over corners 1216 of cover glass 1200 by a second distance 1218 that is larger than first distance 1214.

Use of eave 1210 may result in a coating layer having a perimeter edge located further away from the perimeter edges of a cover glass around the corners of the cover glass than the perimeter edges of cover glass along the sides (e.g., long and short sides) of the cover glass. In other words, distance Y may be larger around the corners of the cover glass than along the sides of the cover glass. Such a coating layer may be desirable because, in many cases, when an electronic device is damaged (e.g., from a large impact, for example, a user dropping the device), a cover glass tends to fail (crack or completely fracture) round the corners of the cover glass. Thus, a coating layer that is spaced further away from the corners of a cover glass may be beneficial for minimizing any detrimental effects resulting from edge-to-edge coating of such a coating layer while allowing the largest possible area on the cover glass to be coated with the coating layer.

In some embodiments, second distance 1218 may be 1%, 5%, 10%, 20%, 30%, 40%, 50%, 60%, 70%, 80%, 90%, or 100%, or within any range having any two of these values as endpoints, larger than first distance.

In addition to compensating for the linear thermal expansion of a mask itself, the dimensions of a contact portion of a mask (and in particular D_{M}) may be tailored to compensate for the mismatch between the coefficient of thermal expansion for a typical cover glass material and the material of the mask. In some embodiments, D_{M} of a contact portion at room temperature may be tailored to prevent damage to a cover glass when the material of the mask thermally expands.

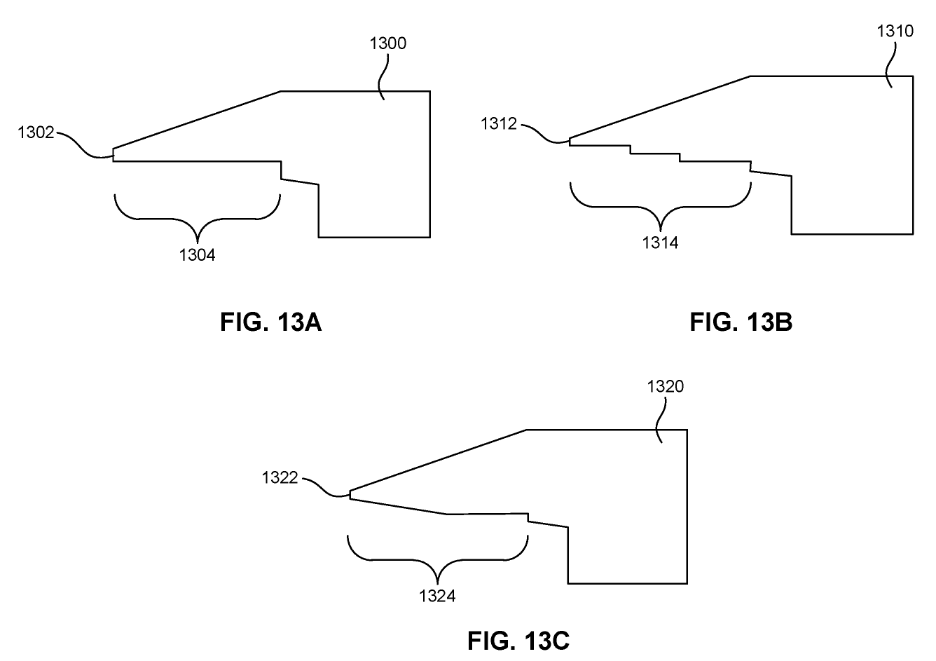

FIGS. 13A-13C show various shapes for bottom surfaces of eave portions according to some embodiments. In some embodiments, the shape of the bottom surface of an eave portion may be tailored to the edge shape of a cover glass (e.g., 2D, 2.5D, or 3D cover glass). In some embodiments, the shape of the bottom surface of an eave portion may be tailored depending on what type of coating profile around the perimeter edge of the coating is desired.

FIG. 13A shows an eave portion 1300 having an edge 1302 and a flat bottom surface 1304. FIG. 13B shows an eave portion 1310 having an edge 1312 and a stepped bottom surface 1314. FIG. 13C shows an eave portion 1320 having an edge 1322 and an angled bottom surface 1324.

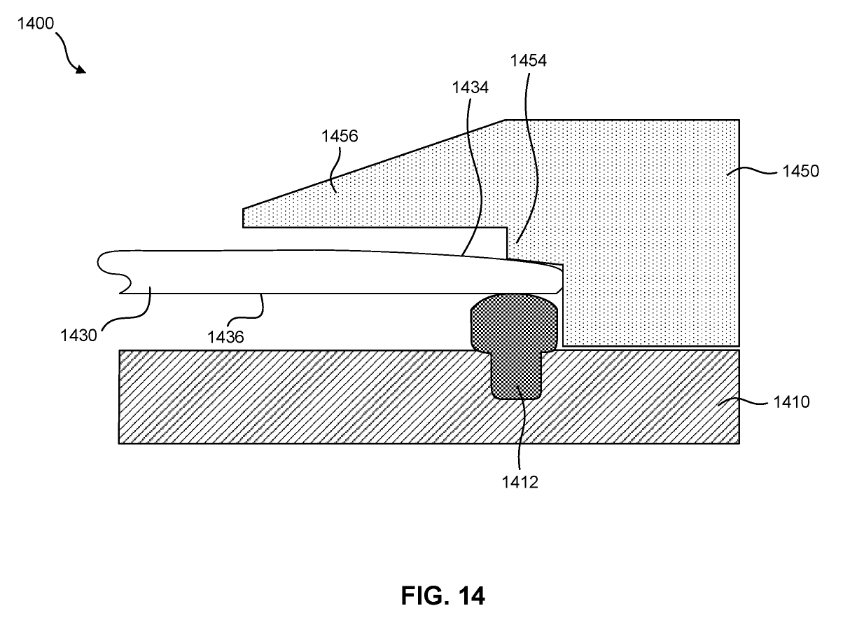

FIG. 14 shows an apparatus 1400 for fixing and masking a cover glass 1430 according to some embodiments. Apparatus 1400 may include a base plate 1410. Apparatus 1400 may also include a mask 1450 having a frame, a contact portion 1454, and an eave portion 1456 having the same dimensions and relationships with cover glass 1430 as decried above with regards to, for example, mask 350 and cover glass 330. In some embodiments, contact portion 1454 may be an elastic contact portion the same as or similar to elastic contact portion 454.

In some embodiments, base plate 1410 of apparatus 1400 may include a gasket 1412 configured to contact a bottom surface 1436 of cover glass 1430. Gasket 1412 may be composed, in whole or in part, of an elastic material the same as or similar to the elastic material of elastic contact portion 454. Gasket 1412 may serve to ensure contact between contact portion 1454 and a top surface 1434 of cover glass 1430, thus creating a seal between top surface 1434 and contact portion 1454. In operation, gasket 1412 presses against bottom surface 1436 of cover glass 1430 when base plate 1410 and mask 1450 are assembled around cover glass 1430. The pressing of gasket 1412 on bottom surface 1436 forces top surface 1434 of cover glass 1430 into contact with contact portion 1454.

By creating a seal between contact portion 1454 and top surface 1434, gasket 1412 may serve to prevent leakage of a coating layer between contact portion 1454 and top surface 1434 during deposition, which can cause abnormal deposition of the coating layer at the edge of coating layer and thus visual defects at the edge. Gasket 1412 may also serve to reduce the machine tolerances needed to create a seal between contact portion 1454 and top surface 1434 due to its conformable nature.

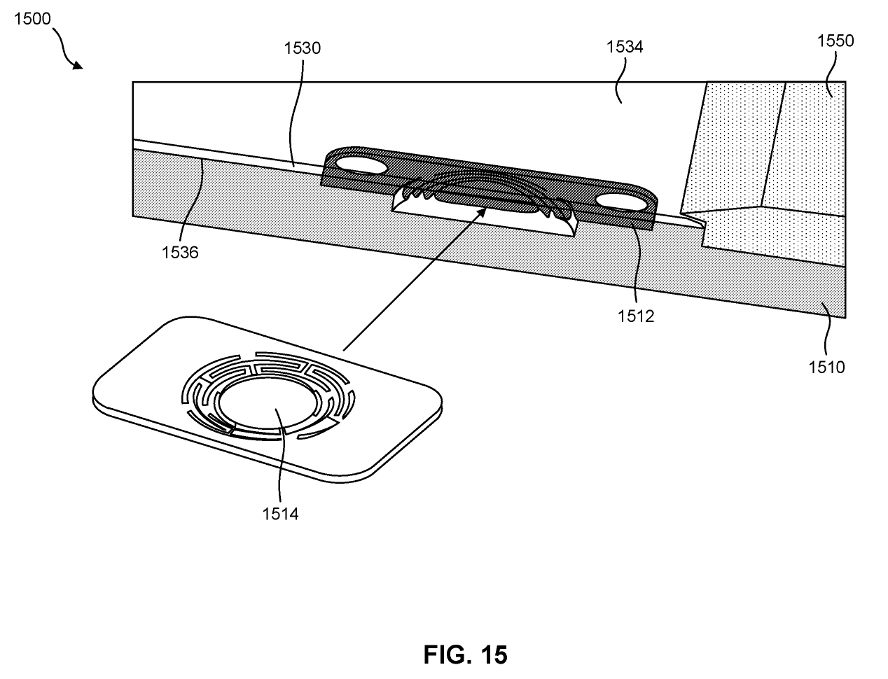

FIG. 15 shows an apparatus 1500 for fixing and masking a cover glass 1530 according to some embodiments. Apparatus 1500 may include a base plate 1510. Apparatus 1500 may also include a mask 1550 the same as or similar to masks 350/450. In some embodiments, base plate 1510 may include a spring plate 1512 including a spring 1514 configured to contact a bottom surface 1536 of cover glass 1530. Similar to gasket 1412, spring plate 1512 may serve to ensure contact between a contact portion of mask 1550 and a top surface 1534 of cover glass 1530, thus creating a seal between top surface 1534 and the contact portion.

In operation, spring 1514 presses against bottom surface 1536 of cover glass 1530 when base plate 1510 and mask 1550 are assembled around cover glass 1530. The pressing of spring 1514 on bottom surface 1536 forces top surface 1534 of cover glass 1530 into contact with the contact portion of mask 1550. In some embodiments, the top surface of spring 1514 may be coated with a polymeric material, for example Teflon, to avoid damaging (e.g., scratching) bottom surface 1536 of cover glass 1530.

By creating a seal between the contact portion of mask 1550 and top surface 1534, spring plate 1512 may serve to prevent leakage of a coating layer material between the contact portion and top surface 1534 during deposition, which can cause abnormal deposition of the coating layer material at the edge of coating layer and thus visual defects at the edge. Spring plate 1512 may also serve to reduce the machine tolerances needed to create a seal between the contact portion of mask 1550 and top surface 1534 due to its conformable nature.

FIGS. 16A-16C show various cover glass edge shapes that may be coated using a coating process discussed herein. As used herein, “2D cover glass” includes a cover glass having a perimeter edge with a chamfered shape on the front and/or back surfaces of the cover glass adjacent to the perimeter edge. The chamfered shape on the front and/or back surfaces may be formed by, for example, a finishing method including mechanical grinding. A 2D cover glass may have a chamfered shape on the front and back surfaces of the cover glass that is the same or different. As used herein, “2.5D cover glass” means a cover glass having a perimeter edge with a curved surface on its front side. The curved surface may be formed by, for example, a mechanical polishing method. The curved surface on the front side of a 2.5D cover glass is smoother to the touch than 2D cover glass. As used herein, “3D cover glass” means a cover glass having a bent perimeter edge to form a non-planar shape. Bent perimeter edge may be formed by, for example, thermal forming and/or cold-forming. A 3D cover glass has a curved bottom surface and a curved top surface adjacent to the perimeter edge of the cover glass.

FIG. 16A shows a perimeter edge 1602 of a 2D cover glass 1600. In general, perimeter edge 1602 of a 2D cover glass is finished by a mechanical grinding method to create a chamfered shape on the front and back surfaces of cover glass adjacent to perimeter edge 1602. In some embodiments, the chamfered shape on the front and back surfaces of cover glass 1600 may be the same. As shown in FIG. 16A, cover glass 1600 may be coated with a coating layer 1604a/b, but perimeter edge 1602 and a region adjacent to perimeter edge 1602 of cover glass 1600 is devoid of coating layer 1604a/b (e.g., in a first region of cover glass 1600 over a distance Y). Coating layers 1604a/b may include coating edges 1606a/b and non-uniform coating thickness profiles adjacent to the coating edges 1606a/b as discussed herein.

As illustrated in FIG. 16A, the distance Y from perimeter edge 1602 to coating layer edge 1606a/b (i.e., the width of a first region on cover glass 1600) may be varied. Distance Y is equal to distance 508 as discussed above in regards to FIG. 5. This distance may be varied by adjusting the dimensions of an eave portion (e.g., eave portion 356) and the relationships of that eave portion with cover glass 1600. For example, coating edge 1606a may be located on a flat top surface of cover glass 1600 adjacent to perimeter edge 1602 as shown on the left side of FIG. 16A. As another example, coating edge 1606b may be located on a chamfered surface adjacent to perimeter edge 1602 as shown on the right side of FIG. 16A.

FIG. 16B shows a 2.5D cover glass 1610 according to some embodiments. 2.5D cover glass 1610 may include a perimeter edge 1612 that is finished with a mechanical polishing method to form a curved surface on its front side. As such, 2.5D cover glass 1610 may have a perimeter edge 1612 having a flat bottom surface and a curved top surface adjacent to perimeter edge 1612. Cover glass 1610 may be coated with a coating layer 1614, but perimeter edge 1612 and a region adjacent to perimeter edge 1612 of cover glass 1610 is devoid of coating layer 1614 (e.g., in a first region of cover glass 1610 over a distance Y). Coating layer 1614 may include a coating edge 1616 and a non-uniform coating thickness profile adjacent to the coating edge 1616 as discussed herein. In some embodiments, as shown for example in FIG. 16B, coating edge 1616 may be located on the curved top surface of cover glass 1610 adjacent to perimeter edge 1612.

FIG. 16C shows a 3D cover glass 1620 according to some embodiments. 3D cover glass 1620 may be formed under high temperature to bend an outer peripheral portion including its perimeter edge 1622. As such, 3D cover glass 1620 may have a curved bottom surface and a curved top surface adjacent to perimeter edge 1622. Similar to cover glasses 1600 and 1610, cover glass 1620 may be coated with a coating layer 1624, but perimeter edge 1622 and a region adjacent to perimeter edge 1622 of cover glass 1620 is devoid of coating layer 1624 (e.g., in a first region of cover glass 1620 over a distance Y). Coating layer 1624 may include a coating edge 1626 and a non-uniform coating thickness profile adjacent to the coating edge 1626 as discussed herein.

FIG. 17 shows an apparatus 1700 for masking and fixing a cover glass 1730. Apparatus may include a base plate 1710 and a mask 1750 with a contact portion 1754 but without an eave portion. Contact portion 1754 may contact a portion of a top surface 1734 of cover glass 1730 during use. The structure of mask 1750 shown in FIG. 17 may result in the formation of a coating layer having edges formed with a uniform thickness (e.g., edges formed at about a 90 degree angle (e.g., 85 degrees to 95 degrees) relative to top surface 1734), like the edge shown in FIG. 8A. Such edge may be visible to the naked eye and thus may be aesthetically undesirable and distracting to a user.

Since mask 1750 lacks an eave portion, it may be difficult to control the distance between the perimeter edge of coating and a perimeter edge 1732 of cover glass 1730. In order to achieve a high degree of control, mask 1750 must be machined with high machine tolerances to ensure that contact portion 1754 extends over a perimeter portion of cover glass 1730 at the appropriate distance. This may be particularly difficult for 2.5D and 3D cover glasses. Mask 1750 may also be susceptible to leakage because a large amount of coating material may be deposited at the point of contact between contact portion 1754 and top surface 1734 of cover glass 1730. As previous discussed, leakage of a coating material may result in visual defects at the edge of the coating layer.

Also because mask 1750 lacks an eave portion, the dimension D_{M} of contact portion may the only dimension that can be adjusted to change the distance between the perimeter edge of a coating layer and perimeter edge 1732 of cover glass 1730. In other words, D_{M} may the only dimension that can be adjusted to change distance Y. This may be particularly problematic for relatively large distances of Y because contact portion 1754 must be machined to extend over a larger perimeter portion of cover glass 1730 without damaging cover glass 1730 during deposition. This may also particularly problematic due to the different coefficients of thermal expansion for cover glass 1730 and mask 1750. For example, typical cover glass materials may have coefficients of thermal expansion three times less than that the coefficient of thermal expansion of an aluminum material used to make mask 1750. The eaved masks discussed herein avoid these limitations and problems associated with apparatus 1700.

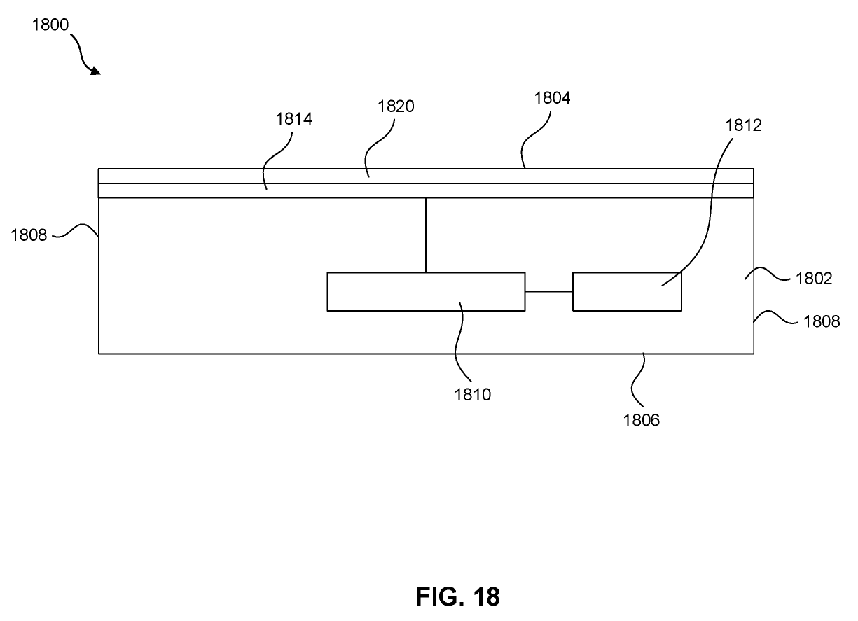

FIG. 18 shows a consumer electronic product 1800 according to some embodiments. Consumer electronic product 1800 may include a housing 1802 having a front (user-facing) surface 1804, a back surface 1806, and side surfaces 1808. Electrical components may be provided at least partially within housing 1802. The electrical components may include, among others, a controller 1810, a memory 1812, and display components, including a display 1814. In some embodiments, display 1814 may be provided at or adjacent to front surface 1804 of housing 1802.

As shown for example in FIG. 18, consumer electronic device 1800 may include a cover glass 1820. Cover glass 1820 may serve to protect display 1814 and other components of electronic device 1800 (e.g., controller 1810 and memory 1812) from damage. In some embodiments, cover glass 1820 may be disposed over display 1814. Cover glass 1820 may be made using a coating process as discussed herein and may be the same as or similar to cover glasses discussed herein (e.g., cover glass 500). Cover glass 1820 may be a 2D, 2.5D, or 3D cover glass. In some embodiments, cover glass 1820 may define front surface 1804 of housing 1802. In some embodiments, cover glass 1820 may define front surface 1804 of housing 1802 and all or a portion of side surfaces 1808 of housing 1802. In some embodiments, consumer electronic device 1810 may include a cover glass defining all or a portion of back surface 1806 of housing 1802.

While various embodiments have been described in the context of coating a cover glass, other glass-based articles (including glass ceramic articles), for example but not limited to, architectural glass windows, automotive glass windows, camera lenses, and glass ceramics for appliance articles, may be coated and processed in the same manner as discussed herein.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “or,” as used herein, is inclusive; more specifically, the phrase “A or B” means “A, B, or both A and B.” Exclusive “or” is designated herein by terms such as “either A or B” and “one of A or B,” for example. The indefinite articles “a” and “an” and the definite article “the” to describe an element or component means that one or at least one of these elements or components is present, unless otherwise stated in specific instances.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.”

Directional terms as used herein—for example up, down, right, left, front, back, top, bottom—are made only with reference to the figures as drawn and are not intended to imply absolute orientation.

As used herein the term “glass-based” is meant to include any material made at least partially of glass, including glass and glass-ceramics. “Glass-ceramics” include materials produced through controlled crystallization of glass. In embodiments, glass-ceramics have about 30% to about 90% crystallinity. Non-limiting examples of glass ceramic systems that may be used include Li2O×Al2O3×nSiO2 (i.e. LAS system), MgO×Al2O3×nSiO2 (i.e. MAS system), and ZnO×Al2O3×nSiO2 (i.e. ZAS system).

The present embodiment(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

1. A method of coating a glass-based article, the method comprising:
disposing a mask over a glass-based article, wherein:
the glass-based article has a perimeter edge, a first annular perimeter portion disposed inside and extending from the perimeter edge, a second annular perimeter portion disposed inside and extending from the first annular perimeter portion, and an inner portion disposed inside the second annular perimeter portion;
the mask comprises an aperture comprising a periphery with an eave comprising an edge thickness of 0.3 mm or less; and
when the mask is disposed over the glass-based article:
the mask contacts at least a portion of the first annular perimeter portion of the glass-based article;
the eave extends over the second annular perimeter portion of the glass-based article;
the aperture is disposed over the inner portion of the glass-based article; and
a bottom surface of the eave is disposed at least 150 microns above the second annular perimeter portion of the glass-based article; and
depositing a coating layer over the glass-based article while the mask is disposed over the glass-based article.

2. The method of claim 1, wherein an upper surface of the eave has a positive slope of 30 degrees or less extending away from the edge of the eave, measured relative to a plane of the glass-based article.

3. The method of claim 1, wherein disposing the mask over the glass-based article further comprises fixing the glass-based article to a base plate with the mask.

4. The method of claim 1, wherein the glass-based article comprises two long sides comprising a length measured in a first direction and two short sides comprising a length measured in a second direction perpendicular to the first direction, and
wherein, at room temperature before deposition of the coating layer, the eave extends over the second annular perimeter portion of the long sides of the glass-based article by a first distance and extends over the second annular perimeter portion of the short sides of the glass-based article by a second distance that is different from the first distance.

5. The method of claim 4, wherein the first distance is less than the second distance.

6. The method of claim 1, wherein the first annular portion begins at the perimeter edge and extends to a distance A inside the perimeter edge, and wherein A is in the range of 0.1 mm to 1.0 mm.

7. The method of claim 1, wherein the second annular portion begins at an interior edge of the first annular perimeter portion and extends to a distance B inside the interior edge of the first annular perimeter portion, and wherein B is in the range of 0.5 mm to 2.0 mm.

8. The method of claim 1, wherein the first annular portion begins at the perimeter edge and extends a distance A inside the perimeter edge and the second annular portion begins at an interior edge of the first annular perimeter portion and extends to a distance B inside the interior edge of the first annular perimeter portion, and wherein the sum of A and B is less than or equal to 3.0 mm.

9. The method of claim 1, wherein the coating layer comprises a scratch resistant coating layer.

10. The method of claim 1, wherein the coating layer is deposited over a least a portion of the second annular perimeter portion of the glass-based article.

11. The method of claim 10, wherein the coating layer comprises a non-uniform coating thickness in the second annular perimeter portion of the glass-based article.

12. The method of claim 11, wherein the non-uniform coating thickness gradually decreases in thickness when moving from the inner portion towards the first annular perimeter portion.

13. The method of claim 11, wherein the non-uniform coating thickness is not visible to the naked eye on the glass-based article.

14. The method of claim 1, wherein the mask comprises an elastic portion that contacts at least a portion of the first annular perimeter portion of the glass-based article when the mask is disposed over the glass-based article.

15. The method of claim 1, wherein the glass-based article is a cover glass.

16. An apparatus for masking the perimeter edge of a glass-based article during a coating process, the apparatus comprising:
a mask comprising:
a contact portion configured to contact a first annular perimeter portion of the glass-based article; and
an eave portion configured to extend over a second annular perimeter portion of the glass-based article, the eave portion defining an aperture and comprising an upper surface, a bottom surface and a peripheral edge,
wherein the peripheral edge comprises an edge thickness of 0.3 mm or less measured at 250 degrees C., and
wherein the bottom surface of the eave portion at the peripheral edge is configured to be located at least 150 microns above an interior edge of a second annular perimeter portion of the glass-based article at a temperature of 250 degrees C.

17. The apparatus of claim 16, wherein the upper surface of the eave portion has a slope of 30 degrees or less measured relative to the bottom surface at a temperature of 250 degrees C.

18. The apparatus of claim 16 or claim 17, wherein the contact portion comprises an elastic material.

19. The apparatus of claim 18, wherein, at room temperature, the eave portion comprises two long sides comprising a length measured in a first direction and two short sides comprising a length measured in a second direction perpendicular to the first direction, and
wherein the long sides extend from the contact portion by a first distance and wherein the short sides extend from the contact portion by a second distance different from the first distance.

20. The apparatus of claim 19, wherein the first distance is less than the second distance.

21. The apparatus of claim 1, further comprising a base plate configured to hold the glass-based article in a predetermined position.

22. The apparatus of claim 21, further comprising the glass-based article disposed on the base plate and releasable fixed to the base plate with the mask.

23. An article comprising:
a cover glass comprising:
a body comprising a first surface comprising a perimeter portion and a central portion, the perimeter portion comprising at least a portion of a perimeter edge of the first surface; and
a coating disposed on the central portion but not on the perimeter portion, the coating comprising a non-uniform coating thickness region at the periphery of the coating adjacent to the perimeter portion.

24. The article of claim 23, wherein the coating is a scratch resistant coating.

25. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover glass disposed over the display,
wherein the cover glass comprises the article of claim 23.
